(19) United States
(12) Patent Application Publication
(10) Pub. No.: US 2022/0184871 A1
(43) Pub. Date: Jun. 16, 2022

(54) Method for Producing a Multiplayer, Surface-Structured Panel, and a Panel Produced by this Method

(71) Applicant: Flooring Technologies Ltd., Kalkara (MT)

(72) Inventor: Frank Oldorff, Schwerin (DE)

(21) Appl. No.: 17/433,633

(22) PCT Filed: Feb. 20, 2020
(86) PCT No.: PCT/EP2020/054498

§ 371 Date: Aug. 25, 2021

(30) Foreign Application Priority Data
Mar. 1, 2019 (EP) 19160259.8

(51) Int. Cl. B29C 48/21; B29C 48/00; B29C 48/07

(52) U.S. Cl. CPC B29C 48/21; B29C 48/002; B29L 2007/001; B29C 48/0023; B29C 48/07

(57) ABSTRACT

Provided is a method for producing a multilayer, surface-structured panel, in particular a multilayer, surface-structured flooring panel. The method includes the steps of: providing at least one plastic carrier panel, in particular in the form of a continuous strand; introducing surface structures on at least one side of the plastic carrier panel by means of embossing; applying at least one primer to the structured surface of the plastic carrier panel; printing the plastic carrier panel by direct printing to form a decorative layer; applying an anti-wear layer containing abrasion-resistant particles; applying at least one lacquer layer; and curing the layer structure.

### CROSS-REFERENCE TO RELATED APPLICATIONS

This application is the United States national phase of International Application No. PCT/EP2020/054498 filed Feb. 20, 2020, and claims priority to European Patent Application No. 19160259.8 filed Mar. 1, 2019, the disclosures of which are hereby incorporated by reference in their entirety.

### BACKGROUND OF THE INVENTION

### Field of the Invention

The present invention relates to a method of manufacturing a multilayer surface-textured panel, a panel manufactured by said method, and a production line for carrying out said method.

### Description of Related Art

Currently, the main floor coverings used are ceramic tiles, wood coverings (such as parquet floors), laminate, PVC coverings, but also textile floor coverings (such as carpets). Flooring made of PVC is often preferred in public and commercial places, but also in the home due to its resistant properties, ease of installation and low cost.

Floor coverings based on PVC are divided into several categories and subcategories. In particular, a distinction is made between traditional PVC flooring and the so-called LVT (Luxury Vinyl Tile) flooring.

Traditional PVC flooring essentially uses PVC as a base material with plasticizers, resulting in a flexible product that can be easily printed and placed on a floor. Traditional PVC products are among the most cost-effective floor coverings currently available.

The LVT products include, among others, PVC coverings and multilayer floor coverings, which have a hard core and are in turn divided into two classes. These include, on the one hand, WPC products (WPC=wood plastic composites or waterproof plastic composites), which originally comprise a layer of a wood-plastic mixture as the core layer. In addition to the use of wood to reduce costs, foaming the substrate can also be an alternative.

On the other hand, multi-layer PVC flooring includes SPC flooring, the core layer of which consists of a plastic component (usually PVC) and a larger proportion of minerals. Due to the larger mineral content, the stiffness, weight and density are higher.

The production of SPC floor coverings (SPC=stone plastic composite) has been growing strongly in terms of volume in recent years. In the simplest case, the product consists of a carrier, a decorative layer and a wear layer.

The substrate consists of a highly filled thermoplastic, such as polyvinyl chloride or polypropylene, with chalk or talc usually used as fillers. The decorative layer is usually a printed thermoplastic film, which also has PVC or PP as its material base. In the simplest case, the wear layer is a transparent, thermoplastic film (PVC or PP).

During production, the carrier is first produced in an extruder, and directly afterwards the decorative and wear films are calendered on. The surface structure of the product is created by the structuring of the calender. The higher the desired wear class is to be, the thicker the wear film must be. This not only leads to cost disadvantages, but also to transparency problems with the higher wear classes.

It is also known to provide panels with a surface structure, whereby a thermoplastic layer is applied to a plastic carrier plate, into which structures are introduced using a mechanical press element (such as a short-cycle press) after heating the thermoplastic layer (DE 20 2011 110 956 U1).

In the known processes for the production of decorated plastic panels, the decoration is therefore always carried out first, preferably with a decorative paper, and only then is a structure introduced into the decoration. A disadvantage is that when using carrier plates already provided with a decorative paper, a considerable amount of adjustment is required to compensate for the undefined paper growth caused by printing and pressing in order to allow the decoration and structure to run synchronously with each other. The visual and haptic impression of the structured surface is also insufficient.

It is known from EP 1 820 640 B1 that wood-based panels with a decor-synchronous structure can be produced, whereby a structure and/or a relief is first embossed into the upper side of the wood-based panel, and the decor is subsequently printed onto this. In this case, a two-dimensional structure is embossed into a fully cured wood fiber or wood-based panel using press plates. In addition to wood fibers, wood-based panels typically contain thermosetting resins (e.g. melamine-formaldehyde resins), so that a so-called “spring back” effect can be observed when embossing wood-based panels.

### SUMMARY OF THE INVENTION

The proposed solution is based on the technical problem of providing a process for the production of a (thermoplastic) SPC floor covering in which the surface of the plastic backing plate is structured and finished more efficiently. The technical properties should not deteriorate and there should be no other product degradation. The productivity of the production line is also not to be impaired by the process.

The object is solved by a method having features as described herein, a panel having features as described herein, and a production line having features as described herein.

Accordingly, there is provided a method of manufacturing a multilayer surface-textured panel, in particular a multilayer surface-textured flooring panel, which comprises the following steps:
providing at least one plastic carrier plate consisting of at least two layers, in particular in the form of a continuous strand,
wherein the at least two-layer plastic carrier plate can be produced from at least two different plastics by means of co-extrusion,
wherein one of the layers is formed from a hard plastic and the other layer is formed from a plastically deformable, structurable plastic,
introducing of surface structures on at least one side of the plastic carrier plate by means of embossing;
applying at least one primer to the textured surface of the plastic backing plate;
direct printing of the plastic carrier plate with the formation of a decorative layer;
applying a wear protection layer containing abrasion-resistant particles;
applying of at least one coating layer; and
curing of the layer structure.

The production of the plastic carrier plate can precede the above process. The plastic carrier plate is first prepared as a continuous strand and then cut to size if necessary.

As indicated above, the plastic backing panel consists of at least two layers, one layer, preferably the lower layer, being made of a non-plastically deformable plastic with high hardness, in particular high Shore hardness. This lower, hard layer gives the panel the necessary stiffness and hardness for use as a floor covering. The Shore hardness serves as a measure of the material hardness and is determined by means of the penetration depth of a test specimen into the plastic material (DIN 53505). The Shore hardness D of the bottom layer, especially when hard PVC (PVC-U) is used, can lie in a range between 75 and 95.

The second, preferably upper layer, is made of a plastically deformable plastic, so that this second upper layer can be structured in the production process, which at the same time forms a softer elastic surface that is more comfortable to walk on.

The plastic carrier plate (or the SPC core) can be made of different thermoplastics, such as polyvinyl chloride (PVC) or polypropylene (PP), PVC being the preferred plastic. The different strength and impact resistance of the at least two different layers of the plastic carrier plate can be adjusted in particular by fillers and additives.

Thus, the plastic with high hardness and impact strength for the lower layer has the following composition:
20-40 wt % PVC, preferably 25-35 wt % PVC,
60-80 wt % limestone, preferably 65-75 wt % limestone;
optionally 3-15 wt %, preferably 5-10 wt % of a recycled plastic (recyclate), and optionally other auxiliaries.

The plastic compound used for the lower, hard layer preferably contains no plasticizer. In particular, it is preferable to use rigid PVC (PVC-U) for the lower layer.

In the case of adding a recycled plastic material, PVC (i.e. the same plastic) should preferably be used. Also, the recyclate should be small ground before extrusion

The plastically deformable plastic for the upper layer has essentially the same composition as the lower, hard layer, with the difference that a plasticizer is added in the upper layer in an amount up to 40 wt %, preferably up to 20 wt %. In one embodiment, the quantitative composition of the lower layer could then be as follows:
20-40 wt % PVC, preferably 25-35 wt % PVC,
40-60 wt % limestone, preferably 45-55 wt % limestone;
20-30 wt % plasticizer, preferably 20-25 wt % plasticizer;
optionally 3-15 wt %, preferably 5-10 wt % of a recycled plastic (recyclate), and optionally other auxiliaries.

Stabilizers, waxes, lubricants, impact modifiers and other auxiliaries can be added as additives. A preferred stabilizer comprises Ca—Zn and can be added in an amount between 1 and 3 wt %, preferably 2 wt % of the compound to be extruded. Polyethylene waxes (PE waxes) can be used as waxes.

In the case of the addition of a plasticizer, it may be selected from the group of phthalate esters, such as dimethyl phthalate (DMP), diethyl phthalate (DEP), diallyl phthalate (DAP), diisobutyl phthalate (DIBP), butyl decyl phthalate (BDP), ditridecyl phthalate (DITP) and others.

Preferred impact modifiers are CPE impact modifiers which are used in an amount between 0.5 and 1.5 wt %, preferably 1 wt % in the compound to be extruded. The abbreviation CPE stands for chlorinated polyethylene, a copolymer of ethylene and vinyl chloride. Depending on the ratio of the two monomers, the chlorine content in the polymer can vary, unlike in PVC. CPE is used, among other things, as an agent to increase impact strength.

In a preferred embodiment, the compound to be extruded comprises 72 wt % limestone (chalk) and 24 wt % PVC, wherein the plastic compound for the lower layer is free of plasticizer and the plastic compound for the upper layer contains a plasticizer, in the latter case the amount of limestone being reduced accordingly.

It is also possible to use three-layer or multilayer plastic carrier plates.

It is also conceivable to produce the two-layer plastic carrier plate by co-extrusion from a first PVC compound and a second PVC compound, each containing different amounts of calcium carbonate.

In one embodiment of the present process, the plastic carrier plate is first produced as a continuous strand by extrusion of a mixture containing PVC, limestone and optional auxiliaries.

The mixture to be extruded can be provided in various alternatives. In one variant, the mixture to be extruded can be provided in the form of a powder, with the various ingredients being mixed in a mixing device to form a powdery mixture, which is introduced into the extrusion device after optional intermediate storage.

In another variant, the mixture is provided in the form of a compound. The compound consists of the individual components which have already been melted together once and are then comminuted to form processable particles (e.g. pellets) which are fed into the extruder device. Accordingly, a mixing device, intermediate hopper and melting device can be dispensed with when using a compound,

When starting from powdered raw materials, the particle size of the limestone should be similar to the particle size of the PVC powder. This facilitates the production of the powder mixture and avoids segregation or inhomogeneities. Of course, this also applies to the production of the compound.

The extrusion of the mixture is carried out in an extruder with discharge of a plate-like strand. As mentioned above, the mixture of PVC, CaCO₃ or limestone and other additives to be extruded is either prepared in advance by mixing the powdered ingredients, melting the PVC and cooling, or as a finished compound.

The mixture to be extruded then passes through a multi-stage extruder with zones of different temperature, with partial cooling with water. The mixture to be extruded is elastified in the extruder under the influence of temperature and shear force to form a “kneadable” mass. A plate-like strand (e.g. with a maximum width of 1,400 mm) is discharged from the extruder via a slot die onto a roller conveyor.

In a further embodiment, it is provided that the plastic carrier plate is colored by admixing dye particles. The color of the carrier plate can be largely freely determined by the dye particles used. In a particularly preferred embodiment, the plastic carrier plate can have a light gray color, so that the light gray substrate can serve directly as a printable base. In this case, the application of a white primer as a printing base, as described below, can be dispensed with.

In one process variant, the embossing of the surface structures of the thermoplastic SPC system is carried out by means of a structured sheet, a structure generator (e.g. paper, film), a circulating structured strip or a structured roller, preferably a roller or strip. The embossing devices used (such as sheet, tape or roller) are made of metal or have other hard coatings suitable for penetration into a plastically deformable plastic. 3D-printed surfaces are also conceivable, especially since the structure depths are sometimes very large.

In a preferred embodiment, a structured calender roll is used as the embossing tool. The final shaping (including structuring) of the sheet in terms of thickness and flatness takes place only after the extruder in one or more columns of calender rolls, with the structure embossing taking place during simultaneous cooling of the SPC carrier plate. There is linear contact between the deformable carrier plate and the structured calender roll.

After leaving the extruder, the plastic carrier plate has an increased temperature. As explained, this temperature of the plastic carrier plate simplifies the subsequent embossing step, as the structures can be introduced into the surface of the plastic carrier plate with a reduced amount of force.

After embossing, the plastic carrier plate was cooled to 20-40° C. to prevent regression of the embossed structures. The cooling process can take place within the press, in a separate cooling section or by intermediate storage at room temperature.

The introduced surface structures or embossed structures can be joints, relief and/or pores. For the purposes of the present application, joints are linear depressions which can be executed longitudinally and/or transversely to the transport direction and have a depth of 0.2 to 1.5 mm, the shape of the joint being variable. A relief comprises two-dimensional structures with a depth of 0.1 to 0.5 mm. Pores, in turn, are fine structures that can have a structure depth of 0.1 to 0.3 mm. Relief and pores can form superimposed structures.

It is also possible that the structure in the register runs parallel to the decor, so-called EIR structure or decor synchronous structure. This approach enables congruence between structure and decor for an improved imitation of a natural product. For this purpose, position and speed are synchronized between the carrier plate to be structured and the structure generator (roller and/or structure generator paper).

In the further process, the endless strand can be fed as such into the further processing plant for surface finishing in one variant. In another possible variant, the continuous strand can be cut to length. In this case, the continuous strand is cut into separate half-formats and the half-formats are fed to further processing as a plastic carrier plate. It is also possible to feed the half-formats as a quasi-plate strand, i.e. edge to edge, into the further processing plant.

The surface-textured plastic carrier plate is further surface-finished as follows:

In one embodiment, the surface of the plastic carrier plate can be pretreated before printing to improve the adhesion of the subsequent layers. This can be cleaning with brushes and/or plasma or corona treatment.

As explained above, in a next step, at least one primer can be applied to the plastic carrier plate as an adhesion promoter before printing on the same. This primer can comprise a primer layer (e.g. UV coating) and/or a hotmelt (or hotcoating), e.g. in the form of a polyurethane hotmelt.

If a primer is used for priming, the amount of liquid primer applied is presently between 1 and 30 g/m², preferably between 5 and 20 g/m², in particular preferably between 10 and 15 g/m². Polyurethane-based compounds are preferably used as primers.

As indicated, it is also possible to apply a hotmelt (or hotcoating), e.g. in the form of a polyurethane hotmelt, to the surface of the plastic carrier plate or to the primer layer before printing, instead of or in addition to the primer layer.

Both primer and hotmelt can contain inorganic color pigments and thus serve as a white primer layer for the decorative layer to be subsequently printed on. White pigments such as titanium dioxide TiO₂ can be used as color pigments. Other color pigments can be calcium carbonate, barium sulfate or barium carbonate.

It is also conceivable that the primer consists of at least one, preferably at least two or more successively applied layers or coatings, the application quantity between the layers or coatings being the same or different, i.e. the application quantity of each individual layer may vary.

The primer can be applied to the surface of the plastic backing plate using a roller, in particular a rubberized roller.

In a preferred embodiment, a white background is applied to the primer by means of digital printing on the plastic carrier plate. The digital printing inks used for digitally printing the white background are preferably based on UV inks enriched with white color pigments. However, it is also possible to use water-based digital printing inks or so-called hybrid inks. Application by means of digital printing is advantageous because the printing equipment is significantly shorter than a rolling device, thus saving space, energy and costs.

The surface of the plastic carrier plate can therefore be prepared in different ways for the subsequent printing process: In a first variant, a white primer (primer or hotcoating with white color pigments) is applied to the plastic carrier plate. In a second variant, a white digital printing ink is printed on. This can also be done additionally on the (white) primer. In a third variant, a light gray plastic carrier plate is used, which preferably does not require an additional white primer. But even in this case of using a light gray plastic carrier plate, a (white) primer and/or a white digital printing ink can of course be applied before printing.

In a particularly preferred embodiment, the at least one decoration is applied to the (surface-treated and precoated) carrier board by means of a digital printing process. In digital printing, the printed image is transferred directly from a computer to a printing press, such as a laser printer or inkjet printer. This eliminates the use of a static printing form.

Decor printing is carried out according to the inkjet principle in single-pass in which the entire width of the top side to be printed is spanned, with the plates moving under the printer. Four to five colors are applied in separate print head rows, with one or two rows of print heads per color. The colors of the digital printing inks are, for example, black, blue, red, reddish yellow, greenish yellow, optionally CMYK can also be used. However, it is also possible that the carrier plate to be printed is stopped under the printer and the latter passes over the surface at least once during printing.

The digital printing inks optionally include the same pigments used for analog and/or digital printing with water-based inks. The digital printing inks are preferably based on UV inks. However, it is also possible to use water-based digital printing inks or so-called hybrid inks. After printing, drying and/or irradiation of the decorative print takes place.

The printing inks are applied in a quantity of between 1 and 30 g/m², preferably between 3 and 20 g/m², in particular preferably between 3 and 10 g/m².

In one embodiment, the wear protection layer applied to the decorative layer comprises at least a first cover layer, abrasion-resistant particles and at least a second cover layer. The wear protection layer serves to cover the decor and, together with the applied corundum, provides wear resistance against abrasion.

In one embodiment of the present method, the application of the wear protection layer is carried out with the following steps:
applying at least one first covering layer on the printed decorative layer;
uniform scattering of abrasion-resistant particles onto the at least one first cover layer applied to the decorative layer;
applying at least a second cover layer to the layer of scattered abrasion resistant particles.

The first cover layer is applied to the decorative layer as a liquid coating and can consist of a hotcoating or hotmelt layer or also a UV coating. The use of a first cover layer is advantageous because improved adhesion of the subsequently applied particles and the layers applied later is achieved.

A polyurethane hotmelt (or polyurethane hotmelt adhesive) is preferably used as the hotcoating or hotmelt. The PUR hotmelt is applied at an application temperature of approx. 150° C. The use of polyurethane as a hotmelt has the further advantage that post-crosslinking with the surface of the plastic carrier plate takes place, resulting in particularly good adhesion to the surface. The application quantity of the hotcoat as the first cover layer is between 20 and 50 g/m², preferably 30 and 40 g/m².

In the case of using a UV coating; e.g. acrylate-containing coatings, the application quantity of the first cover layer is between 30-80 g/m², preferably 40-70 g/m², particularly preferably 50-60 g/m².

Abrasion-resistant particles are then scattered onto the at least one first cover layer applied to the decorative layer. The advantage of scattering the abrasion-resistant particles is that the quantity and distribution can be adjusted specifically and quickly, and a rapid changeover to different product requirements is possible.

However, it is also conceivable that the abrasion-resistant particles are not sprinkled onto the first cover layer, but are applied together with the first cover layer. This is particularly the case if a UV coating is used as the first cover layer.

In a further embodiment of the present method, abrasion resistant particles, particles of corundum (aluminum oxides), boron carbides, silicon dioxides, silicon carbides are used. Particles of corundum are particularly preferred. Preferably, these are high-grade (white) corundum with a high transparency, so that the optical effect of the underlying decor is adversely affected as little as possible. Corundum has an irregular spatial shape.

The amount of scattered or introduced abrasion-resistant particles is 5 to 50 g/m², preferably 10 to 30 g/m², in particular preferably 15 to 25 g/m². The amount of abrasion-resistant particles applied depends on the abrasion class to be achieved and the particle size. Thus, in the case of abrasion class AC3, the amount of abrasion-resistant particles is in the range between 10 to 15 g/m², in abrasion class AC4 between 15 to 20 g/m², and in abrasion class AC5 between 20 to 25 g/m² when using grit size F220. In the present case, the finished boards preferably exhibit abrasion class AC4. Whereby the test is carried out according to DIN EN 16511—May 2014 procedure A or B “Panels for floating installation—Semi-rigid, multi-layer modular flooring (MMF) with abrasion resistant top layer”.

Abrasion resistant particles with grain sizes in classes F180 to F240 are used. The particle size of class F180 covers a range of 53-90 μm, F220 from 45-75 μm, F230 34-82 μm, F240 28-70 μm (FEPA standard). In a particularly preferred embodiment, corundum particles of class F220 are used.

The abrasion-resistant particles must not be too fine-grained (risk of dust formation), but also not too coarse-grained. The size of the abrasion-resistant particles is thus a compromise.

In a more advanced embodiment, silanized corundum particles may be used. Typical silanizing agents are aminosilanes. Silanization of the corundum particles enables improved adhesion (“docking”) of the corundum particles to the layers presented.

As mentioned above, at least one second cover layer is applied to the layer of scattered abrasion-resistant particles. Preferably, the at least one second cover layer also consists of a hotcoating or hotmelt, e.g. a PU hotmelt or also a UV coating.

The amount of the second cover layer applied to the layer of scattered abrasion-resistant particles varies depending in particular on the amount of the first cover layer applied to the print decoration.

In case of using a hot coating, the amount of hot coating applied as a second cover layer is in a range between 20-50 g/m², preferably 30-40 g/m².

In the case of the use of a UV coating, the application quantity of the second cover layer is between 30-80 g/m², preferably 40-70 g/m², particularly preferably 50-60 g/m².

This results in the following variants for the structure of the wear protection layer: first hotcoating layer—scattered abrasion-resistant particles—second hotcoating layer; first UV coating layer—scattered abrasion-resistant particles—second UV coating layer; abrasion-resistant particles mixed into the first UV coating layer—second UV coating layer.

The at least one coating layer is then applied to the at least one wear protection layer, and here in particular to the second cover layer, the at least one coating layer comprising a topcoat with nanoparticles, e.g. nanoparticles of silica.

The at least one coating layer serves to improve the scratch resistance and, if necessary, to adjust the gloss level. The coating layer consists of a topcoat with nanoparticles, e.g. of silica. The coating, preferably a PU coating, can be applied in an amount between 3 and 50 g/m², preferably 5 to 30 g/m², in particular preferably 10 to 20 g/m² by means of further rollers.

Radiation-curable acrylate-containing coatings are used in particular for the topcoat. Typically, the radiation-curable coatings used contain (meth)acrylates, such as polyester (meth)acrylates, polyether (meth)acrylates, epoxy (meth)acrylates or urethane (meth)acrylates. It is also conceivable that the acrylate or acrylate-containing varnish used is substituted or unsubstituted monomers, oligomers and/or polymers, in particular in the form of acrylic acid, acrylic ether and/or acrylic acid ester monomers, oligomers or polymers. Of importance for the present process is the presence, as defined, of a double bond or unsaturated group in the acrylate molecule. The polyacrylates may also be further functionalized. Suitable functional groups include hydroxy, amino, epoxy and/or carboxyl groups. The aforementioned acrylates allow crosslinking or curing in the presence of UV or electron beams (ESH).

The layer build-up is finally dried and cured.

Radiation curing is thus preferably carried out by exposure to high-energy radiation such as UV radiation or by irradiation with high-energy electrons. Preferred radiation sources are lasers, high-pressure mercury vapor lamps, flashlights, halogen lamps or excimer emitters. The radiation dose usually sufficient for curing or crosslinking is in the range of 80-3000 mJ/cm² for UV curing. If necessary, irradiation can also be carried out in the absence of oxygen, i.e. in an inert gas atmosphere. In the presence of oxygen, ozone is formed, making the surface dull. Suitable inert gases include nitrogen, noble gases or carbon dioxide. The present process is preferably carried out under a nitrogen atmosphere.

The surface-finished panel format can be profiled longitudinally and transversely on automatic milling machines, but separately, so that the milling waste can be recycled.

In a further embodiment of the present method, a lockable tongue-and-groove joint is introduced at at least two opposite edges of the panel. This enables simple and fast floating installation of the panels. Such tongue-and-groove joints are known from EP 1 084 317 B1, among others.

The present process thus enables the production of a multilayer surface-textured panel having the following structure (from bottom to top):
at least one surface-textured plastic carrier plate, in particular a two-layer surface-textured PVC carrier plate;
at least one base coat as an adhesion promoter;
at least one decorative layer printed by direct printing,
at least one anti-wear layer with abrasion-resistant particles provided on the decorative layer;
at least one coating layer provided on the wear protection layer.

The surface structures on the upper side of the plastic carrier plate are preferably joints, relief and/or pores. As already noted above, joints are to be understood as linear depressions which can be executed longitudinally and/or transversely to the transport direction and have a depth of 0.2 to 1.5 mm, the shape of the joint being variable. A relief comprises two-dimensional structures with a depth of 0.1 to 0.5 mm. Pores are fine structures with a structure depth of 0.1 to 0.3 mm. Relief and pores can form superimposed structures.

In one embodiment, the present multilayer surface-textured panel has the following structure (from bottom to top):
at least one surface-structured plastic carrier plate, in particular a two-layer surface-structured PVC carrier plate;
at least one base coat as an adhesion promoter;
at least one decorative layer printed by direct printing,
at least one first cover layer provided on the decorative layer;
at least one layer of abrasion resistant particles on the at least one first cover layer;
at least one second cover layer provided on the layer of abrasion-resistant particles, and
at least one coating layer provided on the second cover layer.

The abrasion-resistant and waterproof panels have a bulk density between 1500 and 3000 kg/m³, preferably 2000 and 2500 kg/m³. The total thickness of the panels is less than 6 mm, between 3 and 5 mm, preferably 3 and 4.5 mm.

In one embodiment, a white base is provided between the primer and the printed decorative layer. The layered structure would be in this embodiment (seen from bottom to top):
at least one surface-structured plastic carrier plate, in particular a two-layer surface-structured PVC carrier plate;
at least one base coat as an adhesion promoter,
at least one white ground;
at least one decorative layer printed directly onto the white ground,
at least one first cover layer provided on the decorative layer;
at least one layer of abrasion resistant particles on the at least one first cover layer;
at least one second cover layer provided on the layer of abrasion-resistant particles, and
at least one coating layer provided on the second cover layer.

In another preferred embodiment, the present panel has the following layered structure (viewed from bottom to top):
at least one two-layer surface-textured PVC carrier plate;
at least one hotcoating as a base coat,
at least one white ground of white digital printing ink;
at least one decorative layer printed directly onto the white ground,
at least one hot coating provided on the decorative layer as a first cover layer;
at least one layer of abrasion-resistant particles on the hotcoating as the first cover layer;
at least one second hot coating provided on the layer of abrasion-resistant particles as a second cover layer, and
at least one coating layer provided on the hotcoating as a second cover layer.

In a still further preferred embodiment, the present panel has the following layered structure (viewed from bottom to top):
at least one two-layer surface-textured PVC carrier plate;
at least one primer as a base coat,
at least one white ground of white digital printing ink;
at least one decorative layer printed directly onto the white ground,
at least one UV coating provided on the decorative layer as a first cover layer;
at least one layer of abrasion-resistant particles on the UV coating as the first cover layer;
at least one second UV coating provided on the layer of abrasion-resistant particles as a second cover layer, and
at least one coating layer provided on the UV coating as a second cover layer.

The production line for carrying out the present process includes the following elements:
at least one extruder;
at least one device for embossing a surface structure into at least one side of a plastic carrier plate, in particular into the surface of a two-layer plastic carrier plate provided with a plastically deformable plastic;
at least one applicator for applying at least one base caot to the at least one plastic support plate;
at least one printer for applying at least one decorative layer;
at least one device provided downstream of the printer in the processing direction for applying at least one wear protection layer;
at least one device for applying a coating layer.

In one variant of the present production line, the manufacturing process for the plastic carrier plate can be upstream. This subsection comprises at least one mixing device for mixing the starting materials for the plastic carrier plate in the processing direction. In the mixing device, the thermoplastic material, in particular PVC, limestone and further additives are mixed together. In a more advanced variant, the section of the production line comprises at least one intermediate hopper arranged downstream of the mixing device in the processing direction for storing the mixture of plastic, limestone and further additives. An extruder is connected to the intermediate bunker in the processing direction. It is also possible to dispense with the mixing device and intermediate hopper. In this case, a finished compound is prepared from the starting materials (e.g. in the form of pellets) and fed into the extruder.

The compound (powder or compound) is elasticized in the extruder and pressed through a profile to form a continuous strand (SPC strand), which is cut to length (i.e. cut to a desired format) and the separated formats are stacked as carrier plates before further processing.

The at least one device for embossing a surface structure may comprise a structured sheet, a structure donor (e.g. paper, foil), a circulating structure belt or a structured roller. Preferred are roller or tape. The embossing devices used (such as sheet, tape or roller) are made of metal or have other hard coatings suitable for penetration into a plastically deformable plastic.

For further surface treatment, the surface-structured carrier plates are separated and first subjected to a pretreatment, such as plasma or corona treatment. The devices required for this are known.

As mentioned above, a base coat (e.g. primer or hotmelt, if necessary enriched with white pigments) is applied to the plastic carrier plate after pretreatment. The application device used for this purpose is preferably in the form of a roller unit.

A white primer can then be applied to the base coat using a digital printer.

In a preferred embodiment, a digital printer is also used to print the decorative layer.

The at least one device provided downstream of the printer in the processing direction for applying at least one first cover layer to the decorative layer is preferably in the form of a roller applicator or a spray unit.

The scattering device for the abrasion-resistant particles provided in the present production line is suitable for scattering powder, granules, fibers and comprises an oscillating brush system. The scattering device consists essentially of a supply hopper, a rotating, structured roller and a scraper. Here, the rotational speed of the roller is used to determine the amount of abrasion-resistant material applied. The scattering device preferably comprises a spiked roller.

In one embodiment of the present production line, it is further provided that the at least one scattering device is surrounded by or arranged in at least one booth, which is provided with at least one means for removing dusts occurring in the booth. The means for removing the dusts may be in the form of a suction device or may be in the form of a device for blowing in air. The blowing in of air can be achieved via nozzles installed at the plate inlet and outlet, which blow air into the booth. In addition, these can prevent air movements from creating an inhomogeneous scatter curtain of abrasion-resistant material.

The removal of dust from abrasion-resistant material from the environment of the scattering device is advantageous, because apart from the obvious health burden for the workers working on the production line, the fine dust from abrasion-resistant particles is also deposited on other equipment parts of the production line and leads to increased wear of the same. Therefore, the arrangement of the scattering device in a cabin serves not only to reduce the health impact of dust on the environment of the production line, but also prevents premature wear.

The scattering device is followed in the processing direction by the device for applying the at least one second cover layer, e.g. a hot coating or a UV coating, which is also in the form of a roller unit.

The final coating layer is also applied using a roller device.

The application devices are followed in the processing direction by devices for curing the layer structure, such as dryers and/or blasters.

### BRIEF DESCRIPTION OF THE DRAWINGS

The solution is explained in more detail below with reference to the figures in the drawings, using an example of an embodiment.

FIG. 1 shows a schematic representation of a production line of a multilayer panel according to one embodiment of the process according to the solution.

### DESCRIPTION OF THE INVENTION

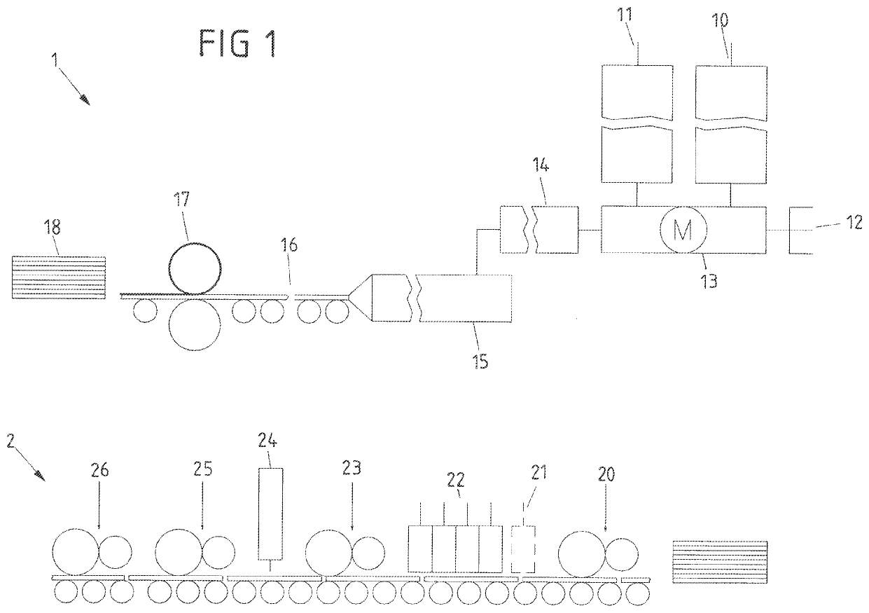

The production line shown schematically in FIG. 1 comprises a first section 1 for producing the plastic carrier plate and a second section 2 for surface processing the plastic carrier plate.

Subsection 1 initially comprises a storage container 10 for PVC powder and a storage container 11 for limestone, which are mixed together in the mixing device 13 with the addition of further auxiliary materials 12.

This powdered mixture of PVC, limestone (or chalk) and further additives can be temporarily stored in an intermediate hopper 14. The intermediate hopper 14 is arranged downstream of the mixing device in the processing direction. The extruder 15 is connected to the intermediate hopper 14 in the processing direction.

As already discussed, a compound made from the individual components in pellet form can also be used directly as the starting component for extruder 15. In this case, storage tanks 10, 11, 12, mixing device 13, and intermediate hopper 14 can be dispensed with.

The mixture (powder or compound) is fed into the extruder device 15 and pressed through a profile to form a continuous strand (SPC strand). The extruder device 15 is designed as a multi-stage extruder with zones of different temperature, with partial cooling with water. A plate-like strand (e.g. with a maximum width of 1,400 mm) is discharged from the extruder via a slot die onto a roller conveyor 16.

Two plastic compounds are provided for the extruder. The first, plasticizer-free blend for the lower, hard layer of the plastic carrier plate consists of 20% by weight PVC, 76% by weight limestone, 1.5% calcium-zinc as stabilizer, 1.5% by weight, 1% CPE as impact modifier and 1% auxiliary ACR812. The second mixture for the upper structurable layer also contains plasticizer.

The still warm endless strand is introduced into a roller device 17 for embossing the surface structure. The embossing device 17 has a structured roller with which joints, reliefs and/or pores are embossed onto the upper side of the continuous strand to match the subsequent decor.

Subsequently, the surface-textured continuous strand is cut to size and the plates are stacked (18).

Subsection 2 for surface processing of the plastic carrier plate starts with a separation and pre-treatment of the carrier plates, such as a plasma or corona treatment (not shown).

In a next step, at least one base coat, preferably a UV coating as a primer or adhesion promoter, is applied to the surface of the plastic carrier plate using a roller unit 20.

In the embodiment shown in FIG. 1, this is followed by a digital printer 21 for applying a white background, followed by one or more digital printers 22 for printing the decorative layer. The decorative printing is carried out according to the inkjet principle in a single-pass process in which the entire width of the top side to be printed is covered, with the plates being moved under the printer.

The at least one device provided downstream of the printer 22 in the processing direction for applying a UV coating as a first cover layer to the decorative layer is designed as a roller application device 23.

Downstream of the roller application device 23 for the first cover layer, a first scattering device 24 is provided for uniformly scattering the abrasion-resistant material, such as corundum, on the upper side of the plastic carrier plate. The abrasion-resistant material used is corundum F220, which measures about 45-75 μm in diameter according to FEPA standards.

The scattering device 24 essentially consists of a supply hopper, a rotating, structured spiked roller and a scraper. The application quantity of the material is determined by the rotational speed of the spreader roller. Depending on the required abrasion class of the product, between 12-25 g/m² of corundum is spread onto the board (AC4 (according to DIN EN 16511)=20 g/m²). From the spiked roller, the corundum falls at a distance of 5 cm onto the panel provided with the decorative foil.

The scattering device 24 is followed in the processing direction by the device 25 for applying a UV coating as a second cover layer.

The final coating layer is also applied using a roller device 26.

The application devices are followed in the processing direction by devices for curing the layer structure, such as dryers and/or radiators (not shown). Suitable cooling devices and cutting devices are provided for further finishing (not shown).

1. A method of manufacturing a multilayer surface-textured panel, in particular a multilayer surface-textured flooring panel, comprising the steps of:
providing at least one plastic carrier plate consisting of at least two layers, in particular in the form of a continuous strand,
wherein the at least two-layer plastic carrier plate can be produced from at least two different plastics by means of co-extrusion, and
wherein one of the layers is formed from a hard plastic and the other layer is formed from a plastically deformable, structurable plastic;
introducing surface structures on at least one side of the plastic carrier plate by means of embossing;
applying at least one primer to the textured surface of the plastic backing plate;
direct printing of the plastic carrier plate with the formation of a decorative layer;
applying a wear protection layer containing abrasion-resistant particles;
applying at least one coating layer; and
curing of the layer structure.

2. The method according to claim 1, wherein the plastic carrier plate is produced from a mixture containing PVC, limestone, optionally a recyclate and optional auxiliary materials by means of extrusion.

3. The method according to claim 1, wherein the plastic compound used for the lower, non-plastically deformable layer of the plastic carrier plate contains no plasticizer and the plastic compound used for the upper, structurable layer of the plastic carrier plate contains plasticizers.

4. The method according to claim 1, wherein the plastic support plate is colored by admixing dye particles.

5. The method according to claim 1, wherein the embossing of the surface structures is carried out by means of a structured plate, a structure generator, a circulating structure strip or a structured roller.

6. The method according to claim 1, wherein the surface structures or embossed structures are joints, relief and/or pores.

7. The method according to claim 1, wherein the primer to be applied to the surface of the plastic carrier plate before printing comprises at least one primer layer and/or at least one PU hotmelt (hotcoating).

8. The method according to claim 1, wherein at least one white primer is applied to the primer before printing.

9. The method according to claim 1, wherein at least one decorative layer is applied by digital printing.

10. The method according to claim 1, wherein the wear protection layer applied to the decorative layer comprises at least a first cover layer, abrasion-resistant particles and at least a second cover layer.

11. The method according to claim 10, wherein particles of corundum (aluminum oxides), boron carbides, silicon dioxides or silicon carbides are used as abrasion-resistant particles.

12. The method according to claim 10, wherein the at least one first cover layer and the at least one second cover layer comprise a UV coating or a hotcoating.

13. The method according to claim 1, wherein the at least one coating layer comprises a UV topcoat.

14. An abrasion resistant and waterproof multilayer panel producible in a process according to claim 1 comprising:
at least one surface-structured plastic carrier plate, in particular a two-layer surface-structured PVC carrier plate;
at least one base coat;
at least one decorative layer printed by direct printing,
at least one wear protection layer with abrasion-resistant particles provided on the decorative layer; and
at least one coating layer provided on the wear protection layer.

15. A production line for carrying out a method according to claim 1 comprising
at least one extruder;
at least one device for embossing a surface structure in at least one side of a plastic carrier plate;
at least one applicator for applying at least one base coat to the at least one plastic support plate;
at least one printer for applying at least one decorative layer;
at least one device provided downstream of the printer in the processing direction for applying at least one wear protection layer; and
at least one device for applying a coating layer.
